(19) United States
(12) Patent Application Publication
(10) Pub. No.: US 2007/0157081 A1
(43) Pub. Date: Jul. 5, 2007

(54) Browser with screen-reading function and browsing processing method

(75) Inventors: Kazuhiro Hara, Toyama (JP); Tooru Osada, Kawasaki (JP); Masahide Yamazoe, Toyama (JP); Masahiro Shitashimo, Toyama (JP); Kazuya Satou, Toyama (JP); Masaaki Uchijima, Toyama (JP); Yoshiyuki Nagawasa, Toyama (JP); Masahiko Tachikawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/650,321

(22) Filed: Jan. 4, 2007

(30) Foreign Application Priority Data
Jul. 6, 2004 (JP) PCT/JP04/09562

(51) Int. Cl. G06F 17/00; G06F 3/048

(52) U.S. Cl. 715/517; 715/784; 715/523; 715/531

(57) ABSTRACT

A browser, with a web page screen-reading function, displays a web page easy to read in synchronism with text screen-reading is possible. The browser determines whether lateral scroll during normal page displaying is occurred reduces, if occurred, the width of displayed component of the display page below the width of the display area and displays the component to be displayed within reduced area to reconstruct the layout of page. The browser, thus, conducts the reconstructed page displayed and vertical scroll so that the character string corresponding to the screen-read part aurally outputted can be displayed.

### CROSS-REFERENCE TO RELATED APPLICATIONS

The present application claims the benefit of PCT international application number PCT/JP2004/009562 filed on Jul. 6, 2004, the subject matter of which is hereby incorporated herein by reference.

### BACKGROUND OF THE INVENTION

1. Field of the Invention

The present invention relates to a browser for browsing data written in a markup language, such as HTML (HyperText Markup Language) data. Particularly, it relates to a browser program with a screen-reading function for performing browsing processing of HTML data, which is provided with a screen-reading function for synthesizing voice from text data in displayed HTML data and outputting the voice, a browser (browsing device) with a screen-reading function, a browsing processing method and a browser program storage medium.

2. Description of the Related Art

As one of data processing functions of a computer, there is a text screen-reading function for synthesizing voice from a document converted into electronic data (text data) or the like and outputting the voice. With this text screen-reading function, a user can listen to the voice outputted from a speaker to grasp the content of the document, instead of looking at the document outputted by a display device or a printing apparatus. As for such data as web pages of the Internet, an HTML data browsing device (browser) usually displays content of a web page in a predetermined display area. In the case where the text screen-reading function is provided, it is possible to output audio data of text in a web page.

The screen-reading function performs processing for displaying text in a manner that the sentences before and after the read position are clearly indicated in association with output of reading voice, in order that a user can confirm which part of the text is being read. Meanwhile, when the display size of a web page exceeds the size of the content display area of the browser, the browser displays only a part corresponding to the display area size, and changes the part to be displayed with a scroll function.

Because a common web page is created on the assumption of a screen the size of which is large to some extent, such as a display device of a personal computer, a user is forced to vertically and horizontally scroll the screen in the case of browsing such common web pages with an apparatus with a small-sized display screen, for example, a mobile information terminal such as a car navigation system, a mobile phone and a PDA (personal digital assistant). Therefore, when reading of a web page is performed in such an apparatus that the display screen size is restricted, a browser has to frequently perform right-and-left-direction (horizontal) scroll to display the reading position of, for example, a horizontally written text.

FIG. 18 is a diagram for illustrating a problem caused when reading is performed while common HTML data 90 (web page) is scrollingly displayed with such a browser whose content display area 91 for displaying a web page is small. As shown at the upper part of FIG. 18, if the browser does not display a pronounced part 92 in the content display area 91 in the case where the display size of the HTML data 90 of a web page exceeds the horizontal width of the content display area 91, then the web page is horizontally scrolled in order to display the pronounced part 92 accompanying output of voice. And, as shown at the lower part of FIG. 18, the displayed part of the web page is switched so that the relevant pronounced part 92 is included in the content display area 91. Furthermore, the reading progresses and the relevant pronounced part 92 moves, the displayed part of the web page is switched, and the pronounced part 92 is displayed in the content display area 91 similarly. A user feels such frequent switching of display troublesome.

To make it possible to display a web page without such horizontal scroll being caused by displaying a reading position, the following countermeasures have been conventionally taken.

1) As for content to be read, a content provider provides HTML data exclusively for reading in consideration of the display size so that a web page can be displayed without performing horizontal scrolling on the display screen of a predetermined apparatus, and a browser displays a web page exclusively for reading when performing reading.

2) On the browser side, HTML data is reconfigured so that display adapted to reading is performed, based on user-specified HTML tags (for example, <B></B>, <I></I> and the like) or predefined special tags.

For example, in the technique of Patent Document 1 (Japanese Patent Laid-Open No. 2003-223463), special tags for reconfiguration are set in advance in a user profile in which a display appearance desired by a user is described, and a browser displays acquired HMTL data in accordance with the description of the user profile. By setting the special tags for reading in the user profile in advance, display adapted to reading can be performed.

Furthermore, for all text data to be read, voice is synthesized and outputted by the screen-reading function. However, if voice output is performed for all text data that is originally intended to be outputted in character representation, grouping symbols, special symbols and the like in the text data interrupt the natural flow of voice and sound irritating, and may rather prevent grasping of the content.

Accordingly, there is provided a processing method in which grouping symbols, special symbols and the like for which it is not necessary to perform voice synthesis processing and reading are set in advance, and only characters are read by skipping the set symbols in text data, as in the technique of Patent Document 2 (Japanese Patent Laid-Open No. 11-338673).

There are a lot of users who want to obtain information from a website even in a situation where they cannot look at displayed content. There is a high request for a browser which makes it possible to listen to voice output of data of a web page and easily confirm the read position and an interesting image on the display screen.

However, in the case of reading a web page which may cause horizontal scroll by a browser with a small-sized display screen, switching of screens for displaying a read part is performed more frequently. It is a large burden on a content provider to prepare, in advance, different HTML data exclusively for reading which is adapted to the content display area of a browser.

In the case where HTML data to which special tags for reconfiguration are added and a user profile in which a display appearance using the special tags is described are prepared to display a web page reconfigured to be adapted to reading, as in the technique of Patent Document 1, the original web page configuration is not held in the reconfigured web page. Furthermore, since only particular information is extracted from the original web page when reconfiguration is performed, lack of information may be caused, and there is a possibility that the original information may not be provided.

Meanwhile, a common web page includes a lot of information irrelevant to information obtained as original content, such as specification of links to other pages and advertising banners, and information displayed repeatedly through multiple pages, such as a corporate name and a copyright designation. To read even such information other than the information which a content provider originally intends to provide is redundant, and it may confuse a user.

### SUMMARY OF THE INVENTION

An object of the present invention is to provide a browser program with a screen-reading function which is provided with a screen-reading function for synthesizing voice from text data in a web page and outputting the voice and which displays a web page in a layout adapted to reading in a manner that troublesome screen switching nor lack of content are not caused, without using HTML data exclusively for reading, a browser with a screen-reading function, a browsing processing method and a browser program recording medium.

Another object of the present invention is to provide a browser program with a screen-reading function which is provided with a screen-reading function for synthesizing voice from text data in a web page and outputting the voice and which is capable of reading only the content originally intended to be provided from a web page to be read, a browser with a screen-reading function, a browsing processing method and a browser program recording medium.

In order to achieve the above objects, the browser with a screen-reading function of the present invention is a browser with a screen-reading function which is provided with a reading processing unit for synthesizing voice from text data to output voice data and which converts HTML data to display data to display the display data in a predetermined display area and performs reading processing of the text data in response to a user's request, which is provided with: 1) a horizontal scroll determination processing unit for determining whether or not the display data to be displayed in the display area is displayed in a horizontally scrollable condition; 2) an optimization layout processing unit for, when the display data is displayed in a horizontally scrollable condition, changing the size so that the horizontal width of each of displayed components of the display data is below the horizontal width value of the display area and reconfiguring the layout so that the displayed components that have been changed are included in the display area; and 3) a scroll processing unit for displaying the display data reconfigured by the optimization layout processing unit in the display area in a vertically scrollable condition and displaying a pronounced part of the display data, for which voice output has been performed by the reading processing unit, in the display area in a display appearance different from that for the content other than the pronounced part.

In the case of converting, for example, HTML data such as an Internet web page to display data and displaying it in a predetermined display area, the present invention determines whether or not the display data to be displayed in the display area is displayed in a horizontally scrollable condition, by the horizontal scroll determination processing unit.

Then, when the display data is displayed in a horizontally scrollable condition, the size is changed so that the horizontal width of each of displayed components of the display data is below the horizontal width value of the display area, and the layout is reconfigured so that the displayed components that have been changed are included in the display area, by the optimization layout processing unit. Specifically, by determining the horizontal width value of each of the displayed components of the display data, changing the horizontal width value of a displayed text component for displaying text data among the displayed components to be below the horizontal width value of the display area and reducing the displayed components other than the displayed text component to be within the horizontal width of the display area, the layout of the displayed components is reconfigured so that the display data can be displayed without performing horizontal scrolling.

Then, by the scroll processing unit, the display data reconfigured by the optimization layout processing unit is displayed in the display area in a vertically scrollable condition, and a pronounced part of the display data, for which voice output has been performed by the reading processing unit is displayed in the display area in a display appearance different from that for the part other than the pronounced part.

Thereby, when a web page acquired from the Internet is displayed on a predetermined small screen and reading processing of the text content of the web page is started, the browser of the present invention reconfigures displayed components so that the web page can be displayed on the small screen without performing horizontal scrolling and displays the reconfigured web page in the display area. Then, accompanying the text content for which voice output is being performed by the reading processing unit, the text content of the web page is displayed in such a display appearance that an outputted pronounced part is highlighted.

Furthermore, the browser with a screen-reading function of the present invention is a browser with a screen-reading function which is provided with a reading processing unit for synthesizing voice from text data to output voice data and which converts HTML data to display data to display the display data in a predetermined display area and performs reading processing of the text data in response to a user's request, which is provided with: 1) a unit for storing particular symbol information indicating the range of text data for which voice output is not performed by the reading processing unit; and 2) a read skip range determination processing unit for acquiring text data to be read by the reading processing unit from the HTML data, extracting text data surrounded by a particular start symbol indicating the start position of the range and a particular end symbol indicating the end position from the text data based on the particular symbol information and deleting the extracted text data.

Furthermore, the present invention is provided with a unit for storing particular symbol information in which a combination of a particular start symbol indicating the start position of a range of text data for which voice output is not performed by the reading processing unit and a particular end symbol indicating the end position of the range. The particular information is configured by symbols or characters which can be identified by character codes and may be, for example, “[” and “]”, “*” and “*”, “#” and “#”, “,” and “.” or the like. Furthermore, multiple characters or symbols may be combined, such as “**” and “**”, “##” and “#”.

When the reading processing of text content displayed on a small screen is performed, the read skip range determination processing unit of the browser acquires text data to be read by the reading processing unit from the HTML data, extracts text data surrounded by the combined particular start symbol and particular end symbol from the text data based on the particular symbol information and deletes it from the text data for the reading processing.

Thereby, the present invention is capable of skipping information irrelevant to information originally intended to be provided as content, such as notices and copyright designations, with the use of preset particular symbol information, in the text content to be read. Thereby, a user can efficiently listen to information which a content provider originally intends to provide.

The present invention can be used for a browser installed on a data processing apparatus with a display screen smaller than the display size of a common web page, for example, a car navigation device, a portable small-sized information terminal such as a mobile phone with a data communication function and a PDA, an information appliance (for example, a data processing apparatus incorporated in an integrated kitchen system) and the like. There is a high possibility that such a data processing apparatus is often used in a situation where a user cannot look at content displayed on the display screen, such as during driving or working.

According to the present invention, a web page is displayed accompanying voice output of the content, being adapted to a small-sized display screen without being horizontally scrolled, with a pronounced part for which voice output is performed as the center. Thereby, it is possible to prevent frequent screen switching from being caused in the case of displaying a pronounced part on a display screen with a restricted size. Due to such reading performed in association with display of content, a user can easily confirm a reading position while listening to content when he wants to acquire information from a web page during driving or working.

Furthermore, according to the present invention, it is not necessary to create HTML data exclusively for reading intended for an apparatus with a small-sized display screen, and it is possible to perform reading of content of a common web page intended for a personal computer. Thereby, the burden of content creation on a content provider can be reduced.

Furthermore, according to the present invention, it is possible to perform display in association with reading, without lack of information of the web page. Thereby, a user can browse common web pages intended for a personal computer even with an apparatus with a small-sized display screen.

Furthermore, according to the present invention, it is possible to output voice while skipping information irrelevant to information originally intended to be provided as content. Thereby, a user can efficiently collect useful information of a web page.

### BRIEF DESCRIPTION OF THE DRAWINGS

FIG. 1 is a diagram showing an example of configuration in a preferred embodiment of the present invention;

FIG. 2 is a diagram showing an example of HTML data acquired from a website server;

FIG. 3 is a diagram showing an example of the DOM tree of the HTML data shown in FIG. 2;

FIG. 4 is a diagram showing an example of a widget tree generated from the HTML data shown in FIG. 2;

FIG. 5 is a diagram showing an example of arrangement of widgets based on the widget tree shown in FIG. 4;

FIGS. 6A and 6B are diagrams for showing difference in display of content before and after performing optimization layout processing;

FIG. 7 is a diagram showing an example of display in the case of having performed processing of the present invention for HTML data shown in FIG. 18;

FIG. 8 is a diagram showing the outline processing flow of the present invention;

FIG. 9 is a diagram showing the processing flow of optimization processing;

FIG. 10 is a diagram showing the detailed processing flow of step S24 shown in FIG. 9;

FIG. 11 is a diagram showing the detailed processing flow of step S26 shown in FIG. 9;

FIG. 12 is a diagram showing the detailed processing flow of step S28 shown in FIG. 9;

FIG. 13 is a diagram showing the detailed processing flow of step S3 shown in FIG. 8;

FIG. 14 is a diagram showing a display example of a web page of a common news providing site;

FIG. 15 is a diagram showing another display example of a web page of a common news providing site;

FIG. 16 is a diagram showing the detailed processing flow of read skip range determination processing;

FIG. 17 is a diagram showing the detailed processing flow of reading display processing of step S3 in the case of performing the read skip range determination processing; and

FIG. 18 is a diagram for illustrating a problem about reading position indication display in scrolling display by a browser.

### DETAILED DESCRIPTION OF THE PREFERRED EMBODIMENTS

As a preferred embodiment of the present invention, an embodiment of a browser will be described which displays HTML data acquired from a website server on the Internet on a display device and, when performing reading processing, performs processing for reconfiguring the layout in order to perform optimum display of the web page in association with reading and processing for performing voice output while skipping a range identified from text content based on predetermined particular symbol information.

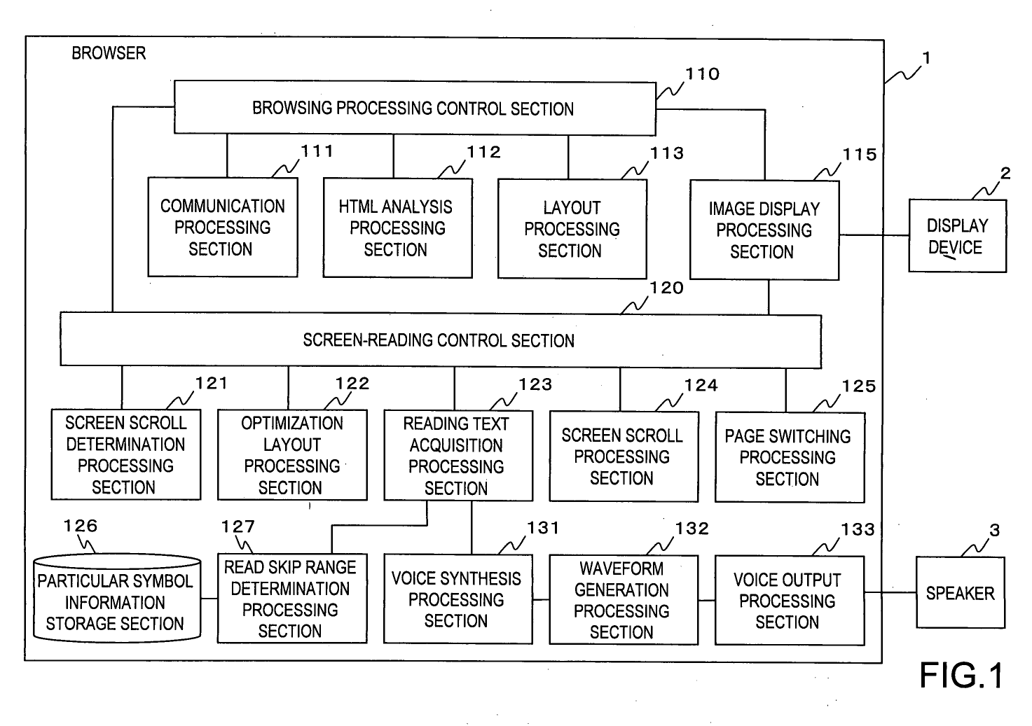

FIG. 1 shows an example of configuration in the preferred embodiment of the present invention.

A browser with a screen-reading function (browser) 1 according to the present invention is provided with a display device 2, a speaker 3, a browsing processing control section 110, a communication processing section 111, an HTML analysis processing section 112, a layout processing section 113, an image display processing section 115, a screen-reading control section 120, a horizontal scroll determination processing section 121, an optimization layout processing section 122, a reading text acquisition processing section 123, a scroll processing section 124, a page switching processing section 125, a particular symbol information storage section 126, a read skip range determination processing section 127, a voice synthesis processing section 131, a waveform generation processing section 132 and a voice output processing section 133.

The browsing processing control section 110 is processing unit for controlling a series of processings related to browsing processing for acquiring HTML data and displaying the data on the display device 2. When a user requests reading, the browsing processing control section 110 notifies the request to the screen-reading control section 120.

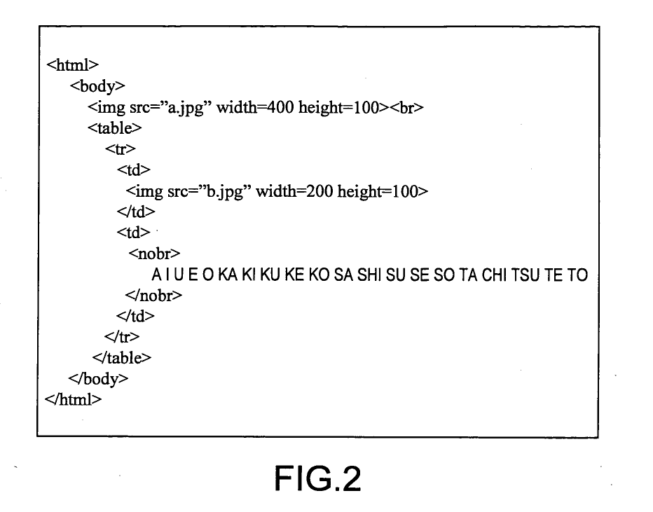

The communication processing section 111 performs processing for acquiring HTML data from a website server in accordance with the HTTP protocol. FIG. 2 shows an example of HTML data acquired from a website server.

The HTML analysis processing section 112 performs processing for analyzing tags of HTML data and converting the data to a format called a DOM (Document Object Model) tree.

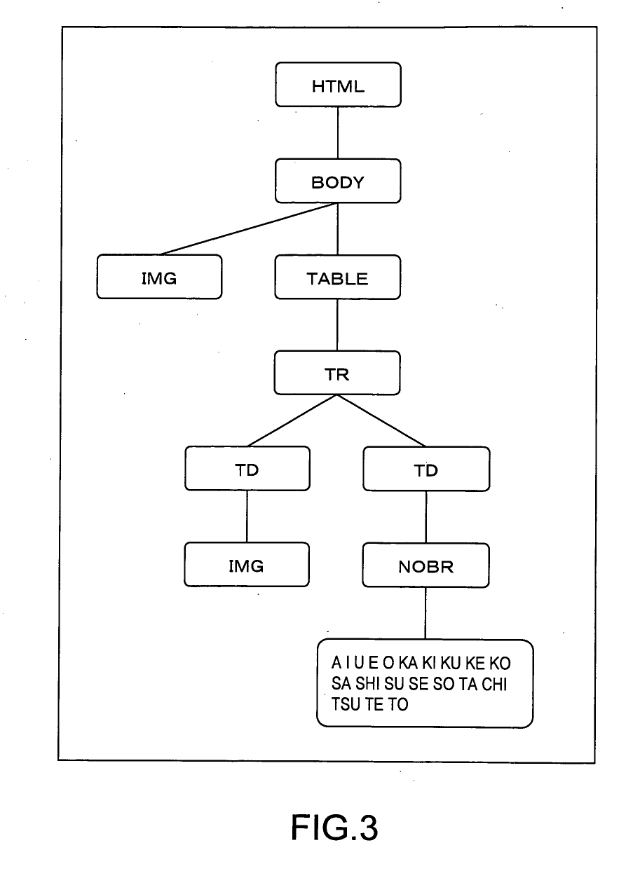

FIG. 3 shows an example of the DOM tree of the HTML data shown in FIG. 2. The DOM tree shows the hierarchical relations among the HTML data.

The layout processing section 113 performs processing for laying out the information of a DOM tree in accordance with tag information. The laid-out HTML data are expressed by displayed components for GUI (graphical user interface) referred to as widgets.

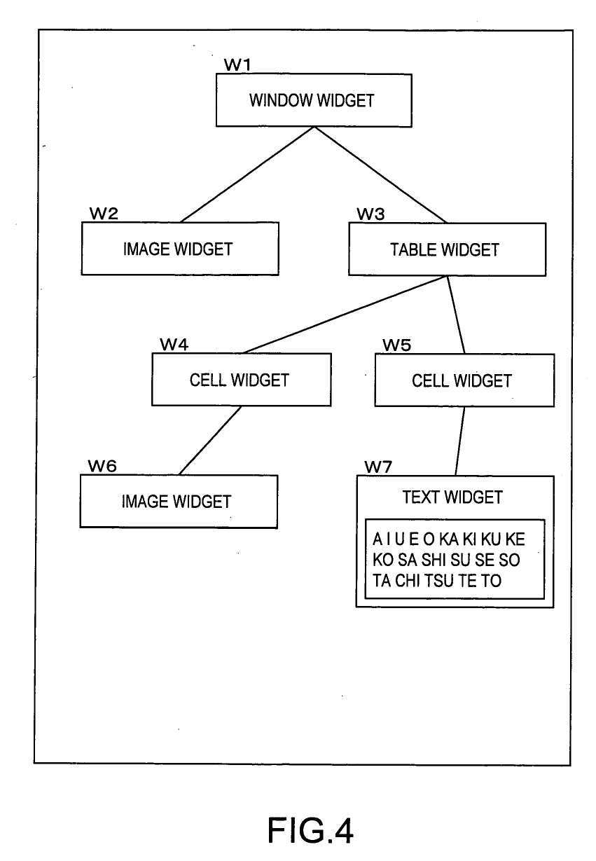

FIG. 4 shows an example of a widget tree generated from the HTML data shown in FIG. 2. The widget tree shows relations among widgets (displayed components) W1 to W7.

The image display processing section 115 performs processing for displaying HTML data on the display device 2 based on information described in a widget tree.

The screen-reading control section 120 performs processing for, when the reading processing of HTML data displayed on the display device 2 is requested by the user of the browser 1, controlling a series of processings related to the reading processing.

The horizontal scroll determination processing section 121 performs processing for determining whether or not a web page currently displayed on the display device 2 is displayed in a horizontally scrollable condition. The optimization layout processing section 122 performs processing for laying out information of a DOM tree in accordance with tag information so that horizontal scroll is not caused in a predetermined content display area of the browser 1. The laid-out HTML data are expressed by displayed components called widgets.

The reading text acquisition processing section 123 performs processing for sequentially acquiring text data for which the reading processing is to be performed, from a DOM tree.

The scroll processing section 124 performs processing for scrollingly displaying a part of text data in HTML data for which voice output is being performed (a pronounced part).

The page switching processing section 125 performs processing for jumping to the URL written on HTML data. Whether or not to jump can be specified by environmental setting.

The particular symbol information storage section 126 performs processing for storing particular symbol information for identifying the range of a part to be skipped during the reading processing, that is, text data for which voice output is not performed among text data to be read. The particular symbol information is set as a combination of a particular start symbol indicating a skip start position and a particular end symbol indicating the end position of the range.

The read skip range determination processing section 127 performs processing for analyzing the character codes of text data acquired as a screen-reading object, and extracting and deleting a read skip range based on the particular symbol information during the reading processing.

The voice synthesis processing section 131 performs processing for converting text data acquired by the reading text acquisition processing section 123 to a phonogram string.

The waveform generation processing section 132 performs processing for converting the phonogram string to waveform data.

The voice output processing section 133 performs processing for outputting the waveform data from the speaker 3 as voice.

<Optimization Layout Processing>

The optimization layout processing will be described below in more detail. It is assumed that content to be processed is the HTML data shown in FIG. 2, and the screen width of the content display area of the browser 1 is 240 pixels.

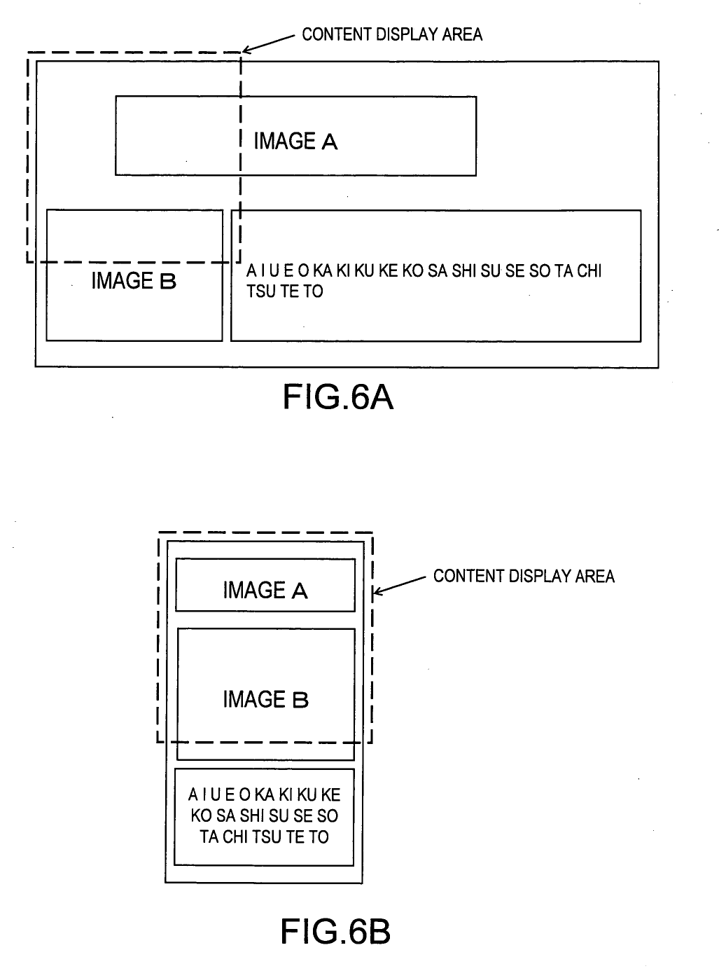

Under the control of the browsing processing control section 110, HTML data acquired from a certain website server is developed into the widget tree shown in FIG. 4, and a web page as shown in FIG. 6A is displayed in the content display area. The screen width of the content display area is 240 pixels, and all the content cannot be displayed at a time. Therefore, the image display processing section 115 displays the content in a horizontally scrollable condition in the content display area. Since the series of processings are common browsing processings, description thereof will be omitted.

When a web page is displayed in such a condition, and the reading processing is requested by a user, the horizontal scroll determination processing section 121 determines that display is performed in a horizontally scrollable condition, and hands the determination result to the optimization layout processing section 122.

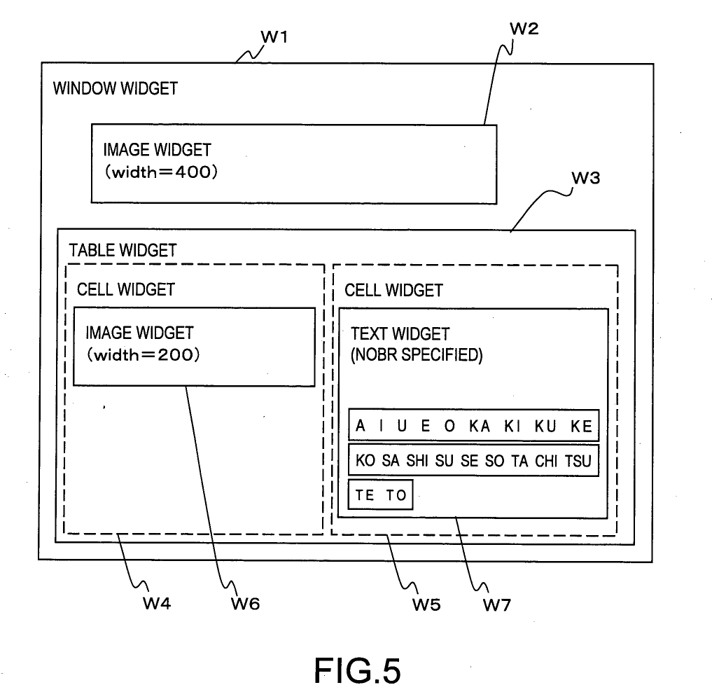

The optimization layout processing section 122 determines arrangement coordinates of the widgets W1 to W7 to display the widget tree in FIG. 4 generated by the layout processing section 113 in the content display area. The widgets are sequentially arranged from upper to lower widgets, the arrangement being started at the upper left of the content display area, in accordance with the hierarchical structure of the widget tree. The respective widgets are arranged by changing their sizes (dimensions) so that they are included within the width of the window widget W1 (hereinafter referred to as the screen width)=240 pixels. FIG. 5 shows an example of arrangement of widgets based on the widget tree in FIG. 4.

First, as for the image widget W2, since the horizontal width of the image widget W2 is larger than the screen width, it is reduced to a size within the image width while the horizontal to vertical ratio of the image is kept.

Next, as for the table widget W3, since the size is not specified, the table widget W3 is determined after the minimum sizes of cell widgets W4 and W5 are determined. First, in order to determine the size of the cell widget W4, the size of a content widget to be included therein is determined. The size of the image widget W6, which is the content of the cell widget W4 can be within the image width, the image is not reduced. Thereby, the size of the cell widget W4 is determined.

Next, in order to determine the size of the cell widget W5, the size of a content widget is determined similarly. Though NOBR (non-breaking) is specified for the character string in the text widget W7, the NOBR (non-breaking) is disabled because the widget does not fit within the image width if character-string wrapping is not performed, and a size corresponding to one character is determined as the size of the minimum cell widget.

By the sizes of the cell widgets W4 and W5 having been determined, the size of the table widget W3 is determined. However, the size of the determined table widget W3 is larger than the screen width, and the two cell widgets W4 and W5 cannot be horizontally arranged. Therefore, as shown in FIG. 6B, the cells are separated so that the cell widget W5 is arranged below the cell widget W4. Then, in accordance with the determined arrangement positions of the cell widgets W4 and W5, layout inside each of the cell widgets is performed.

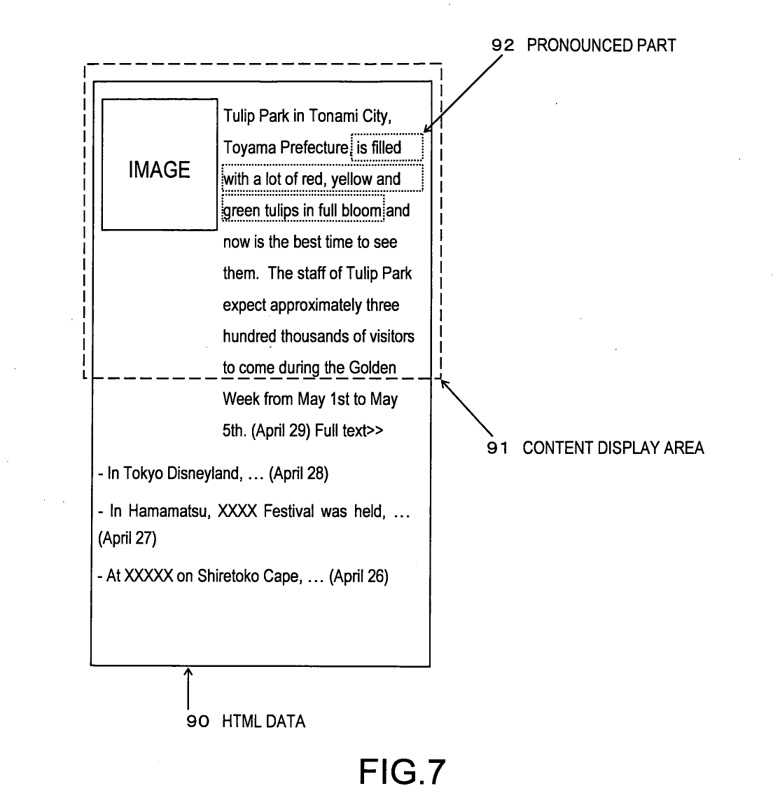

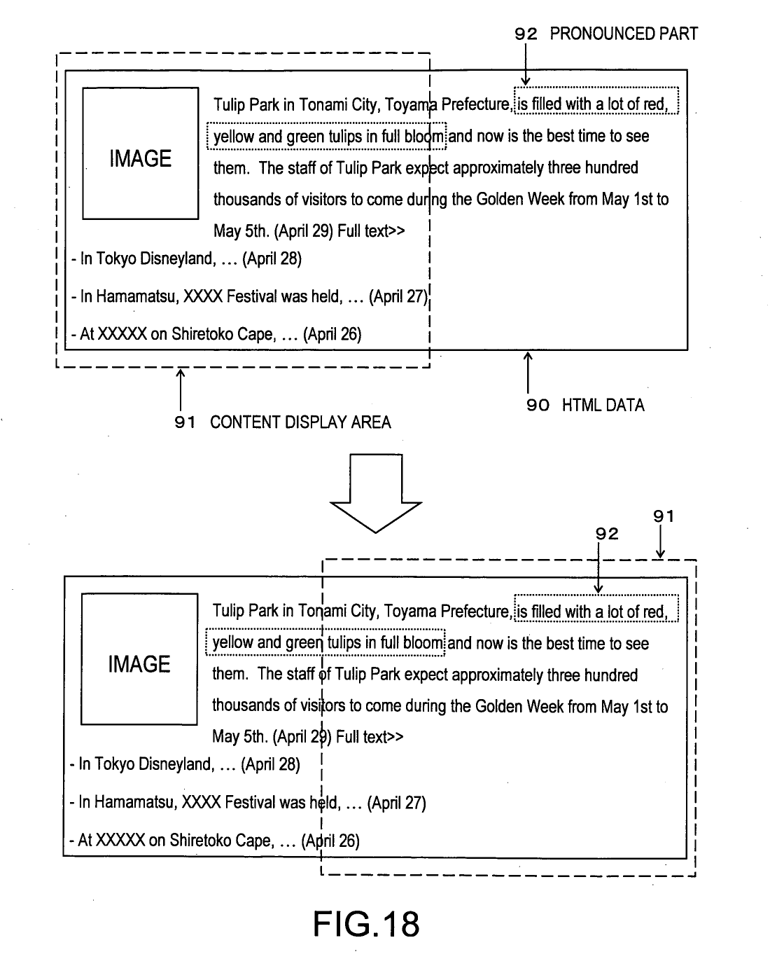

FIG. 7 shows a display example in the case of having performed processing of the present invention for HTML data 90 shown in FIG. 18. According to the present invention, since display processing is performed so that the width of a web page developed from the HTML data 90 fits within the screen width of the content display area, horizontal scroll is not generated. Therefore, in the case of displaying a pronounced part 92 during the reading processing, the screen is switched only by vertical scroll, and frequent screen switching is not caused. Consequently, a user can easily confirm the pronounced part.

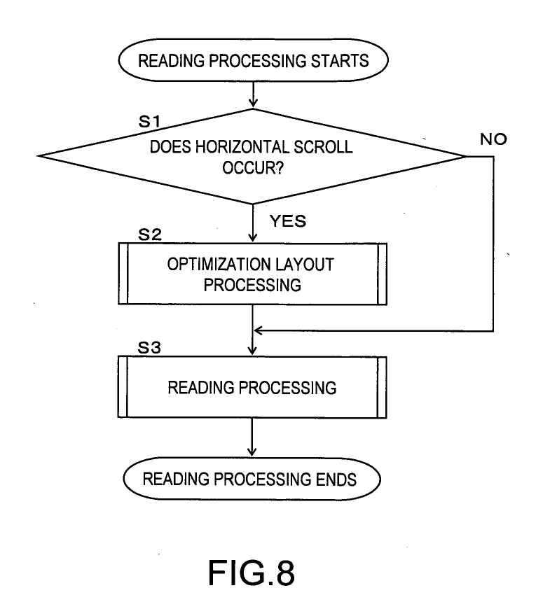

FIGS. 8 to 12 show the processing flow of the present invention.

FIG. 8 shows the outline processing flow of the present invention.

When the reading processing is requested while display processing of HTML data is performed under the control of the browsing processing control section 110, this processing is started. The horizontal scroll determination processing section 121 determines whether or not horizontal scroll is caused (step S1). If it is determined that horizontal scroll is caused, then the optimization layout processing is performed (step S2), and the reading processing is performed (step S3). On the other hand, if it is determined that horizontal scroll is not caused, then the reading processing is immediately performed (step S3).

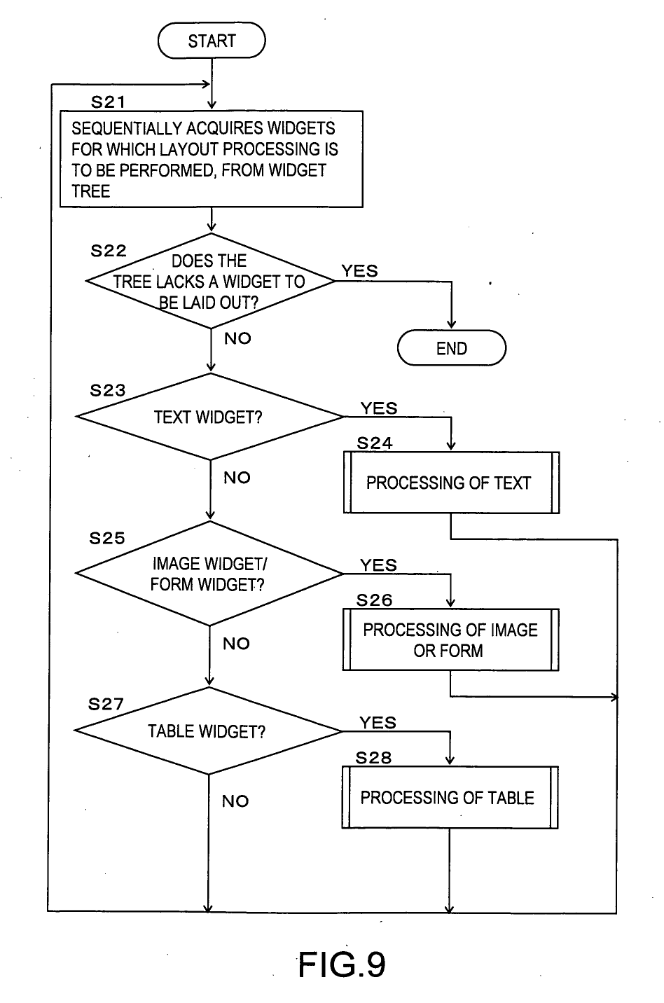

FIG. 9 shows the processing flow of the optimization processing.

The optimization layout processing section 122 sequentially acquires widgets for which the layout processing is to be performed, from a widget tree (step S21). If there is any widget to be laid out (step S22), then it is determined whether the widget is a text widget or not (step S23). If it is a text widget, then processing for text is performed (step S24). If it is not a text widget, then it is determined whether or not the widget is an image widget or a form widget (step S25).

If the widget is an image widget or a form widget (such as Textarea and pushButton), then processing for image or for form is performed (step S26). If the widget is neither an image widget nor a form widget, then it is determined whether it is a table widget or not (step S27). If the widget is a table widget, then processing for table is performed (step S28), and otherwise, the flow returns to the processing of step S21.

If there is not a widget to be laid out at the processing of step S22, then the flow ends.

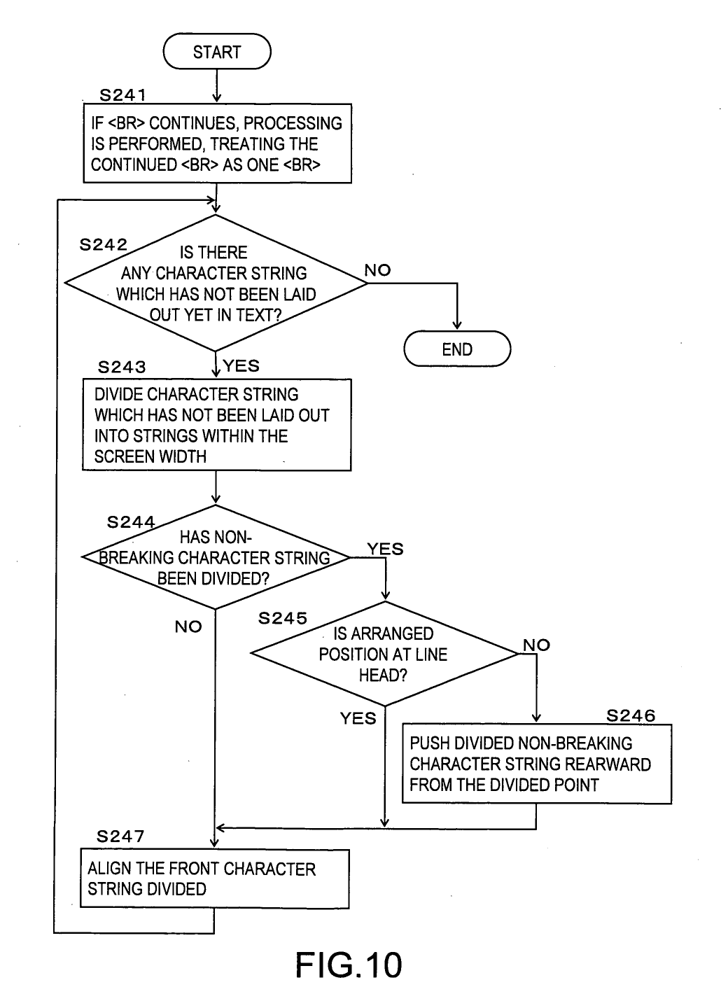

FIG. 10 shows the detailed processing flow of step 24 shown in FIG. 9.

If a tag <BR> continues in text widget, the optimization layout processing section 122 processes the tags <BR> treating it as one <BR> (step S241). Then, it is determined whether or not there is any character string which has not been laid out (step S242). If there is any character string which has not been laid out, then the character string which has not been laid out is divided into strings within the screen width (step S243). Specification of non-wrapping (such as <nowrap> and <nobr>) is assumed to be ineffective.

Furthermore, it is determined whether or not any non-breaking character string (an English word, a numerical value, a character before/after which a line break is prohibited, such as punctuation marks and grouping symbols, or the like) has been divided (step S244). If any non-breaking character string is divided, then it is further determined whether or not the arranged position is the line head (step S245). If the arranged position is not a line head, then the divided non-breaking character string is pushed rearward from the divided point (step S246). On the other hand, if the arranged position is a line head, then the non-breaking character string is left as it is. On the other hand, if a non-breaking character string is not divided, then the front character string divided is aligned (step S247).

If there is not a character string which has not been laid out in the text at step S242, then the flow ends.

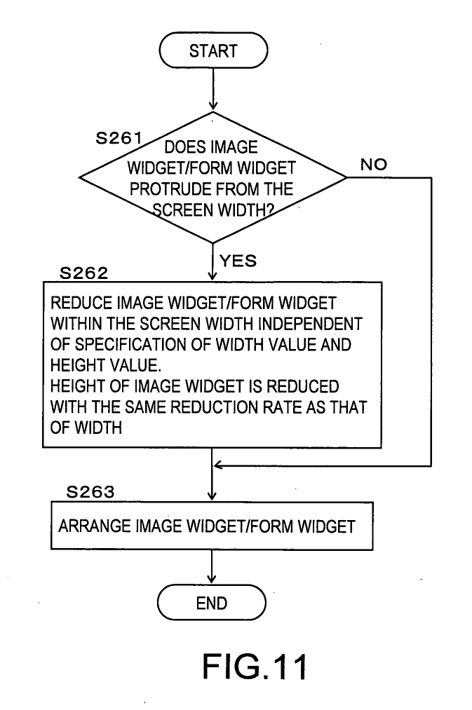

FIG. 11 shows the detailed processing flow of step S26 shown in FIG. 9.

The optimization layout processing section 122 determines whether or not an image widget or a form widget fits within the screen width (step S261). If the image widget or the form widget does not fit within the screen width, then the image or the form is reduced to the screen width independent of whether or not the width value (width) and the height value (height) are specified. The height of the image is reduced with the same reduction rate as that of the width (step S262). On the other hand, if the image widget or the form widget fits within the image width, then the flow proceeds to the processing of step S263.

Then the image or the form is arranged (step S263).

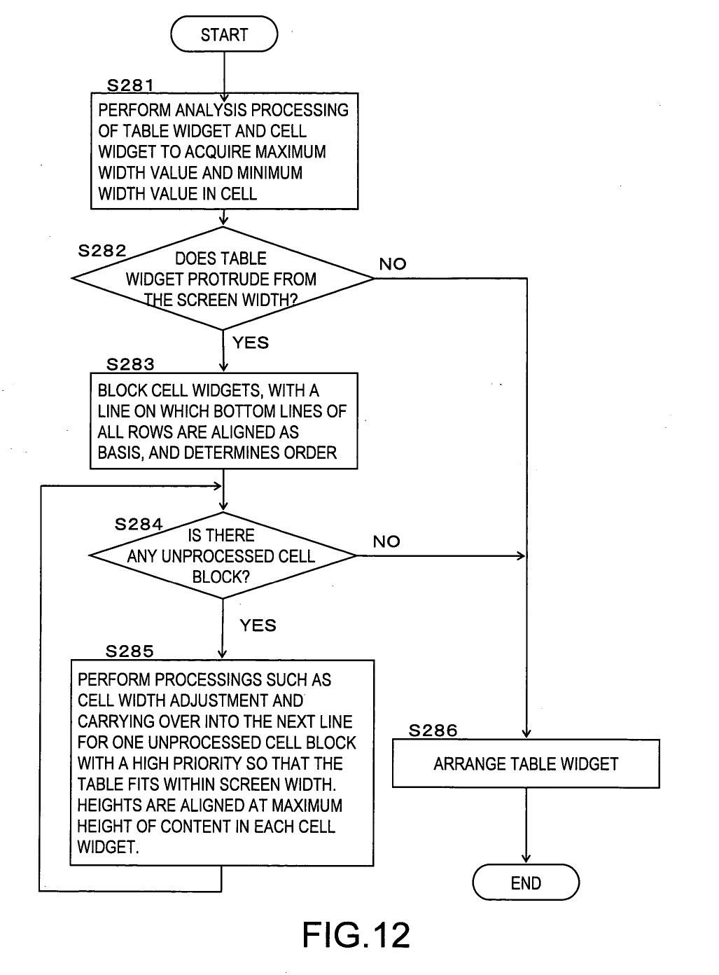

FIG. 12 shows the detailed processing flow of step S28 shown in FIG. 9.

The optimization layout processing section 122 performs analysis processing of a table and a cell to acquire the maximum width value and the minimum width value within the cell (step S281). It is determined whether or not the table fits within the screen width (step S282). If the table does not fit within the screen width, then blocking of cells is performed with a line on which the bottom lines of all the rows in the table are aligned as the basis and the order is determined (step S283). Then, it is determined whether or not unprocessed cell blocks exist (step S284). If there are unprocessed cell block, processings such as cell width adjustment and carrying over into the next line are performed for one unprocessed cell block with high priority so that the table fits within the screen width. The heights are aligned at the maximum height of the content in each cell widget (step S285). Then, the flow returns to the processing of step S284.

On the other hand, if the table fits within the screen width at step S282, or if there is not any unprocessed cell block at the processing of step S284, then the flow proceeds to processing of step S286.

At step S286, the table is arranged, and the flow ends.

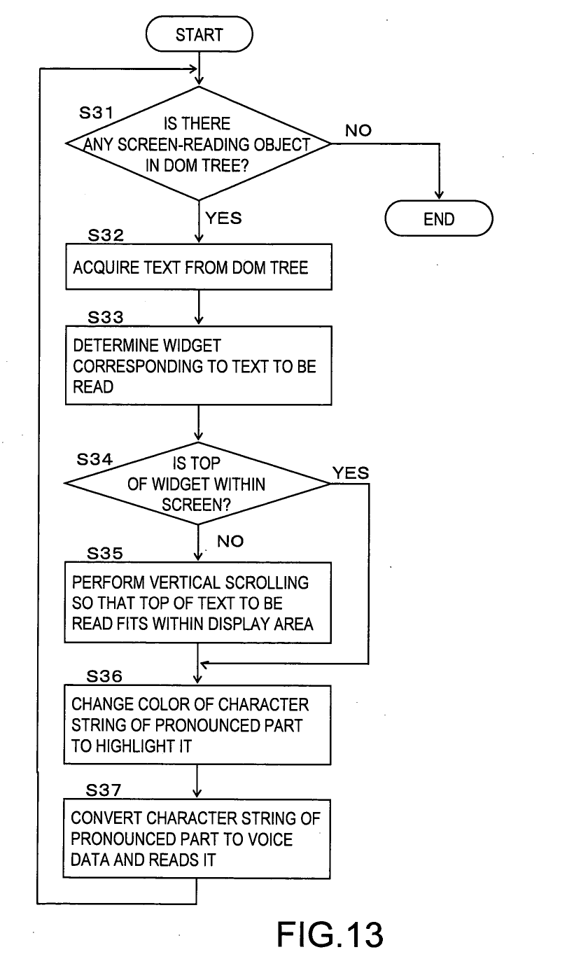

FIG. 13 shows the detailed processing flow of step S3 shown in FIG. 8.

The reading text acquisition processing section 123 determines whether or not there is any text to be read in a DOM tree (step S31). If there is any screen-reading object, the text is acquired from the DOM tree (step S32), and a widget corresponding to the text to be read is determined (step S33).

Then, it is determined whether or not the top of the widget fits within the display area (step S34). If the top of the widget does not fit within the display area, then vertical scrolling is performed so that the top of the text to be read fits within the display area (step S35), and the color of the character string of the pronounced part is changed so that it is highlighted (step S36). Furthermore, the voice synthesis processing section 131, the waveform generation processing section 132 and the voice output processing section 131 convert the character string of the pronounced part to voice data and read it (step S37). After that, the flow returns to the processing of step S31.

On the other hand, if the top of the widget fits within the display area, then the flow proceeds to processing of step S36.

<Read Skip Range Determination Processing>

Processing for determining a part for which voice output is not necessary when content is read will be described below.

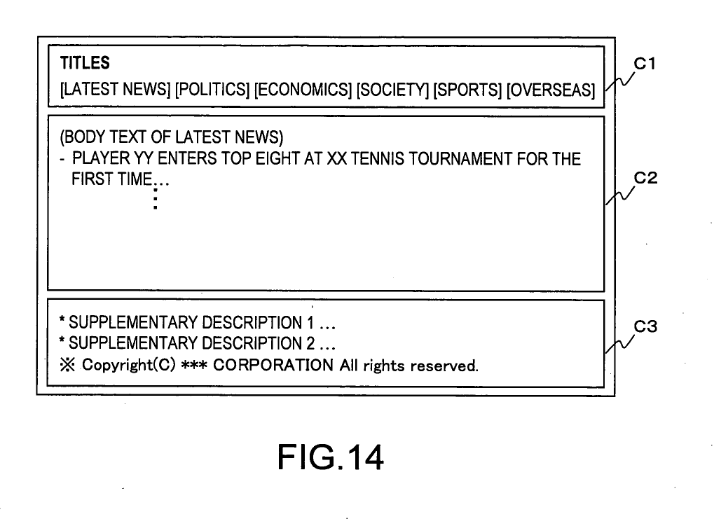

FIG. 14 shows a display example of a web page of a common news providing site. It is news itself that the content provider wants to provide, among the content of the web page shown in FIG. 14. For a user, a title display portion C1 for displaying classification of news and a body text display portion C2 in which the body text of the news is displayed are necessary as screen-reading objects, and a supplementary information display portion C3 for displaying supplementary information, copyright designation and the like is not necessary.

Therefore, symbols which are often used for supplementary information are set as particular symbol information in advance and stored in the particular symbol information storage section 126. The particular symbol information may be a combination of a particular start symbol indicating the start position of a read skip range and a particular end symbol indicating the end position of the read skip range.

The read skip range determination processing section 127 refers to the particular symbol information storage section 126, analyzes the character codes of text data which the reading text acquisition processing section 123 has acquired and stored in a temporary screen-reading text buffer to search for a particular start symbol. If there is a particular start symbol in the text data, then a corresponding particular end symbol is further searched for. Then, a character string surrounded by the particular start symbol and the particular end symbol is deleted from the text data to be read.

For example, a combination of “*” and “*”, “*” and “. (period)”, “,(comma)” and “. (period)” or the like is assumed to be set as particular symbol information. The read skip range determination processing section 127 searches for character codes set as the particular symbol information from the text data of the title display portion C1, the body text display portion C2 and the supplementary information display portion C3 acquired by the reading text acquisition processing section 123. The top character of the text in the supplementary information display portion C3 is “*”, and the last character is “. (period)”, and therefore, the character string of the text in the supplementary information display portion C3 is deleted from the text to be read. Thereby, text data obtained by deleting the supplementary information display portion C3 from the text of the web page displayed as shown in FIG. 14 is stored in the screen-reading text buffer. Then, through the processings by the voice synthesis processing section 131, the waveform generation processing section 132 and the voice output processing section 133, the content of the title display portion C1 and the body text display portion C2, which is the text data in the screen-reading text buffer, is converted to voice and outputted from the speaker 3.

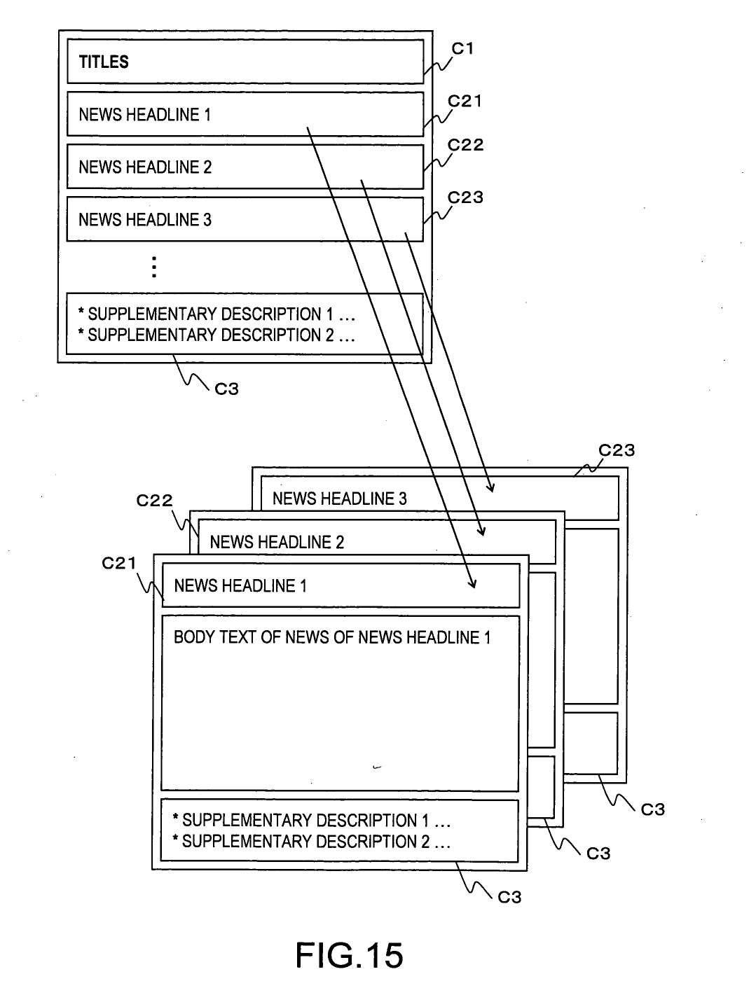

Furthermore, FIG. 15 shows another display example of a web page of a common news providing site. The web pages in FIG. 15 show that the news body text pages are displayed from the news headlines C21, C22, C23, . . . on the top page, respectively. In this case, it is assumed that the supplementary information display portion C3 on the top page is also displayed on the body text page of each of the news. In conventional reading processing, the content of the supplementary information display portion C3 is read every time each page is read.

However, the read skip range determination processing section 127 detects the particular symbols, the top character “*” and the last character “.(period)” of the text data in the supplementary information display portion C3, reads the part surrounded by these particular symbols and deletes it from the text data in the text buffer. Consequently, a user can listen to only the useful body text of the news.

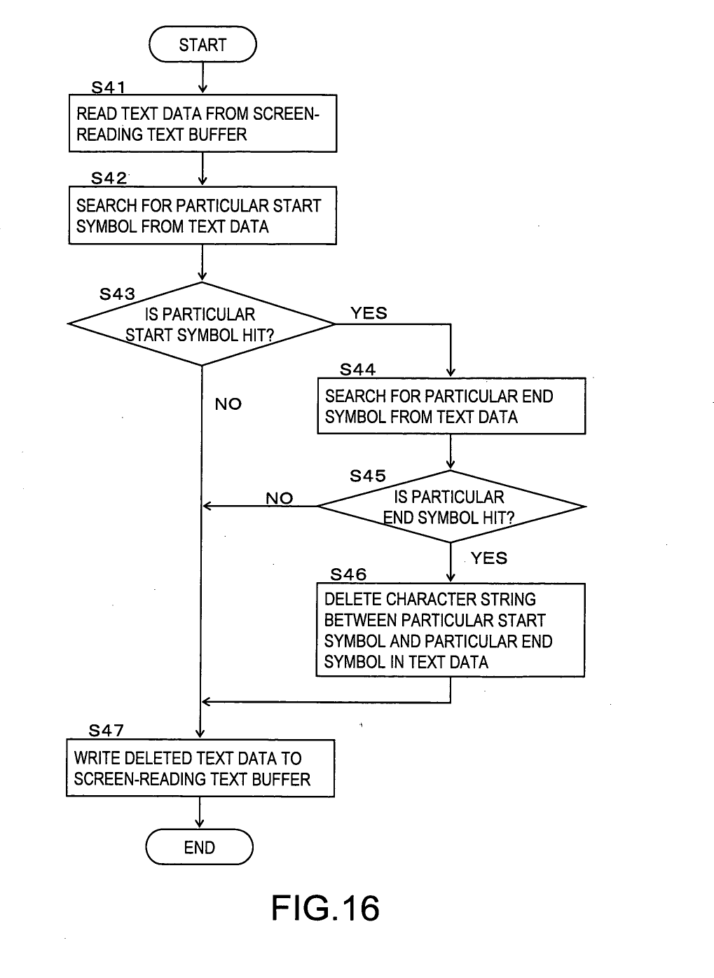

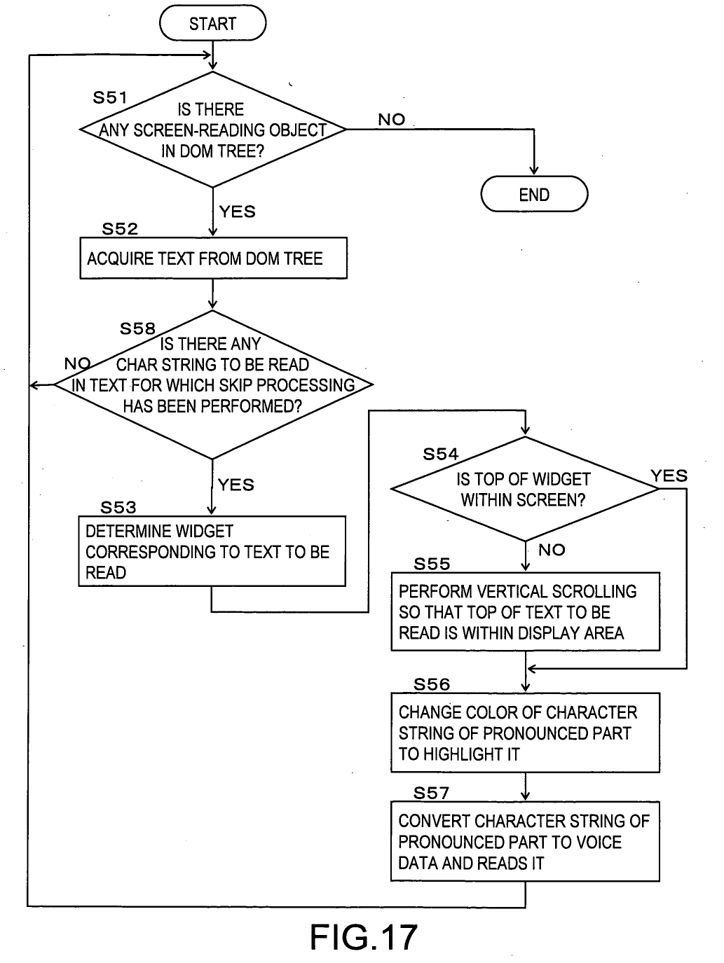

FIGS. 16 and 17 show the processing flows of the present invention.

FIG. 16 shows the detailed processing flow of the read skip range determination processing.

The read skip range determination processing section 127 reads text data from the screen-reading text buffer (step S41). A particular start symbol is searched for from the text data (step S42). If a particular start symbol is hit (step S43), then a particular end symbols is further searched for from the text data (step S44). Then, if a particular end symbol is hit (step S45), then a character string between the particular start symbol and the particular end symbol in the text data is deleted (step S46), and the deleted text data is written back to the screen-reading text buffer (step S47).

On the other hand, if a particular start symbol is not hit at the processing of step S43, then the processing of step S47 is performed.

FIG. 17 shows the detailed flow of the reading display processing of step S3 in the case of performing the read skip range determination processing.

The processings of steps S51 to S57 of the processing flow shown in FIG. 17 correspond to the processings of steps S31 to S37 of the processing flow shown in FIG. 13, respectively. The reading display processing performed in the case of performing the read skip range determination processing is different in that processing of step S58 is performed between the processings of steps S52 and S53.

At the processing of step S58, it is determined whether or not there is any character string to be read in the text for which the read skip range determination processing (skip processing) has been performed. If there is any character string to be read, then the flow proceeds to the processing of step S53. If there is not any character string to be read, then the flow returns to the processing of step S51.

The present invention has been described with the use of an embodiment thereof However, various variations of the present invention are naturally possible within the range of the spirit thereof.

Furthermore, the present invention can be embodied as a processing program to be read and executed by a computer. The processing program realizing the present invention can be stored in a suitable computer-readable recording medium such as a portable medium memory, a semiconductor memory and a hard disk. It is recorded in such a recording medium and provided. Alternatively, it is provided via a communication interface through sending/receiving with the use of various communication networks.

### INDUSTRIAL APPLICABILITY

The present invention can be used for a browser installed on a data processing apparatus with a display screen smaller than the display size of a common web page, for example, a car navigation device, a portable small-sized information terminal such as a mobile phone with a data communication function and a PDA, an information appliance (for example, a data processing apparatus incorporated in an integrated kitchen system) and the like. There is a high possibility that such a data processing apparatus is often used in a situation where a user cannot look at content displayed on the display screen, and there is a high request for a web page screen-reading function which makes it possible to easily confirm a reading position.

What is claimed is:

1. A browser with a screen-reading function which is provided with a reading processing unit for synthesizing voice from text data to output voice data and which converts HTML data to display data to display the display data in a predetermined display area and performs reading processing of the text data in response to a user's request, the browser comprising:
a horizontal scroll determination processing unit for determining whether or not the display data to be displayed in the display area is displayed in a horizontally scrollable condition;
an optimization layout processing unit for, when the display data is displayed in a horizontally scrollable condition, changing the size so that the horizontal width of each of displayed components of the display data is below the horizontal width value of the display area and reconfiguring the layout so that the displayed components that have been changed are included in the display area; and
a scroll processing unit for displaying the display data reconfigured by the optimum layout processing unit in the display area in a vertically scrollable condition and displaying a pronounced part of the display data, for which voice output has been performed by the reading processing unit, in the display area in a display appearance different from that for the part other than the pronounced part.

2. The browser with a screen-reading function according to claim 1, wherein the optimization layout processing unit, in the case of changing the size of each of the displayed components in the optimization layout processing, determines the horizontal width value of each of the displayed components of the display data, changes the horizontal width value of a displayed text component for displaying text data among the displayed components to be below the horizontal width value of the display area and reduces the displayed components other than the displayed text component to be within the horizontal width of the display area so that a character string wraps.

3. A browser with a screen-reading function which is provided with a reading processing unit for synthesizing voice from text data to output voice data and which converts HTML data to display data to display the display data in a predetermined display area and performs reading processing of the text data in response to a user's request, the browser comprising:
a unit for storing particular symbol information indicating the range of text data for which voice output is not performed by the reading processing unit; and
a read skip range determination processing unit for acquiring text data to be read by the reading processing means from the HTML data, extracting text data surrounded by a particular start symbol indicating the start position of the range and a particular end symbol indicating the end position from the text data based on the particular symbol information and deleting the extracted text data.

4. The browser with a screen-reading function according to claim 3, wherein the particular symbol information includes a combination of a particular start symbol and a particular end symbol indicating the end position of the range.

5. A browsing processing method for, with the use of a reading processing unit for synthesizing voice from text data to output voice data, converting HTML data to display data to display the display data in a predetermined display area and performing reading processing of the text data in response to a user's request, the method comprising:
a horizontal scroll determination processing step of determining whether or not the display data to be displayed in the display area is displayed in a horizontally scrollable condition;
an optimization layout processing step of, when the display data is displayed in a horizontally scrollable condition, changing the size so that the horizontal width of each of displayed components of the display data is below the horizontal width value of the display area and reconfiguring the layout so that the displayed components that have been changed are included in the display area; and
a scroll processing step of displaying the display data reconfigured by the optimum layout processing in the display area in a vertically scrollable condition and displaying a pronounced part of the display data, for which voice output has been performed by the reading processing means, in the display area in a display appearance different from that for the part other than the pronounced part.
